(19) United States
(12) Patent Application Publication
(10) Pub. No.: US 2012/0307525 A1
(43) Pub. Date: Dec. 6, 2012

(54) ARRANGEMENT FOR CURRENT CONVERSION WITH AN INVERTER

(76) Inventors: Peter WALLMEIER, Lippstadt (DE); Alexander SATZER, Soest (DE)

(21) Appl. No.: 13/299,414

(22) Filed: Nov. 18, 2011

(30) Foreign Application Priority Data
Jun. 1, 2011 (EP) EP 11 168 490.8

(51) Int. Cl. H02M 3/22

(52) U.S. Cl. 363/15

(57) ABSTRACT

An arrangement for converting current is provided, wherein the terminals of the primary side are led out from the high-current transformer on a first side of the high-current transformer, and the terminals of the secondary side are led out from the high-current transformer on a second side of the high-current transformer. The inverter is arranged on the first side of the high-current transformer and the at least one capacitor is arranged on the second side of the high-current transformer, and the at least one first terminal of the secondary side of the high-current transformer is connected directly, without an intermediately connected electrical line, with the first terminal of the at least one capacitor.

### BACKGROUND OF THE INVENTION

(1) Field of the Invention

The present invention relates to an arrangement for conversion of current.

(2) Description of Related Art

A power supply arrangement is disclosed in the published European patent application EP 2 100 851 A2 by the applicant of the present patent application, wherein the arrangement is suitable and configured for depositing silicon in a reactor according to the Siemens process. For producing a uniform temperature distribution, the thin silicon rods or silicon rods on which the silicon is to be deposited are supplied with a low-frequency current having a frequency of about 50 Hz and with an intermediate-frequency current or a high-frequency current. The current flowing through the rods causes the rods to heat up due to their ohmic resistance. If the current density across the cross-section of the rods is constant, then the same energy is supplied at each location of the cross-section of the rods. The rods can dissipate heat across the exterior surfaces of the rods, so that the regions of the rods proximate to the exterior surfaces are heated up less than the regions in the interior of the rods.

While the low-frequency current causes an identical current density across the cross-section of the rods, the intermediate-frequency or high-frequency current through the rods produces a higher current density in the exterior regions of the rod due to the well-known skin effect. Due to the higher current density in the exterior regions of the rods produced by the skin effect from the intermediate-frequency or high-frequency current, more energy is supplied to the exterior regions of the rods than to the interior regions. The heat loss through the exterior surfaces of the rods can thereby be compensated. The exterior region may also be heated to a higher temperature than the interior regions.

The published application EP 2 100 851 A2 discloses various options for connecting a current supply arrangement for a low-frequency current and a current supply arrangement for an intermediate-frequency current for supplying current to the silicon rods. However, this document does not explicitly disclose the structure of a current supply arrangement for intermediate-frequency current in detail.

Although the European patent application with the application number 10 150 728.3-2207 by AEG Power Solutions B.V. discloses the electrical configuration of a current supply arrangement for an intermediate-frequency current, the mechanical configuration is not disclosed.

The electrical configuration may be implemented as follows:

The arrangement
includes an inverter for producing AC current with a frequency between 2 and 250 kHz from DC current,
includes a high-current transformer for transforming AC current from the primary side to a secondary side, with a nominal current of 300 A at a nominal voltage from 0 to 700 V on a primary side to a current with a nominal current from 0 A to 1500 A at a nominal voltage from 0 to 100 V on the secondary side of the high-current transformer, and
includes at least one capacitor for filtering a voltage having a frequency of less than 2 kHz present on at least one output of the arrangement,
wherein a first terminal of the output of the inverter is connected with a first terminal of the primary side of the high-current transformer, and
wherein a second terminal of the output of the inverter is connected with a second terminal of the primary side of the high-current transformer.

The high-current transformer is connected with the at least one output of the arrangement via two branches,
wherein in at least one first branch of the two branches a first terminal of the secondary side of the high-current transformer is connected with a first terminal of the capacitor and a second terminal of the capacitor is at least indirectly connected with a first terminal of the output, and
wherein in at least one second branch of the two branches a second terminal of the secondary side of the high-current transformer is at least indirectly connected with a second terminal of the output.

However, the mechanical configuration of the current supply arrangement for an intermediate-frequency current or a high-frequency current is not without technical problems which are created, in particular, by the high frequencies and the simultaneously high currents to be supplied by the current supply arrangement. In particular, technical problems were associated with arrangements for converting the low-frequency grid current to the intermediate-frequency or high-frequency output current of the current supply arrangement. One problem was related to the skin effect and the proximity effect which affect the current conduction inside the current supply arrangement and which, although desired in the silicon rods, are undesirable in the converter arrangement. Electromagnetic stray fields associated with the intermediate-frequency or high-frequency currents are also a problem. Solutions which allow the implementation of the electrical configuration in a mechanical configuration are not known and have also not been described or suggested. It has therefore not been possible to this date to implement the concept of supplying intermediate-frequency or high-frequency current to a reactor for producing polysilicon.

This is the basis of the present invention.

### BRIEF SUMMARY OF THE INVENTION

The invention addresses the problem of designing a conventional converter arrangement with the aforementioned electrical configuration so as to minimize undesirable effects during flow of the large high-frequency current from the inverter to the load.

This problem is solved according to the invention with an arrangement, wherein
the terminals of the primary side are led out from the high-current transformer on a first side of the high-current transformer, and the terminals of the secondary side are led out from the high-current transformer on a second side of the high-current transformer,
the inverter is arranged on the first side of the high-current transformer and the at least one capacitor is arranged on the second side of the high-current transformer, and
the at least one first terminal of the secondary side of the high-current transformer is connected directly, without an intermediately connected electrical line, with the first terminal of the at least one capacitor.

The invention is based on several considerations. Firstly, the electrical lines should be as short as possible. The effects associated with the conduction of the high-frequency current can be significantly reduced with this measure alone. Secondly, the phase conductor and the neutral conductor should be routed as close together as possible at locations where they are led out from components of the arrangement of the invention and where electrical lines cannot be avoided. Thirdly, the terminals and electrical lines, unless unavoidable, should have the largest possible surface so that the largest possible cross-section is available for conducting the electric current in spite of the skin effect.

The terminals inside the arrangement according to the invention and at the output of the arrangement according to the invention as well as also electrical lines inside the arrangement according to the invention, through which current flows, have preferably a cross-section with an outside circumference of 0 to 60 cm. Advantageously, a ratio of the circumference of the cross-section through which current flows to the nominal current is 0.04 cm/A. The cross-sectional area may be 1 to 6 cm².

The first side and the second side of the high-frequency transformer may be opposite sides of the high-frequency transformer, for example a top side and a bottom side of the high-frequency transformer.

Preferably, each first terminal on the secondary side of the high-current transformer and the first terminal of the capacitor(s) have a matching hole pattern, so that their terminals can be electrically and mechanically interconnected with screws and the like.

On a first side of the capacitor(s) of an arrangement according to the invention, the first terminal may be led out, while the second terminal of an arrangement according to the invention can be led out on the second side of the capacitor(s). The first side and the second side of the capacitor(s) may be opposing sides of the capacitor(s), for example a top side and a bottom side of the capacitor(s).

The second terminal of each of these capacitors may be connected directly, i.e., without an intermediately connected electrical line, with a first switching contact of a first switch. A second switching contact of the first switch may form a first contact of the output.

Each second terminal of the secondary side of the high-current transformer may be connected via an electrical line with a first switching contact of a second switch. The electrical line may be a metal plate, in particular a copper plate. Alternatively and particularly preferred, each second terminal of the secondary side of the high-frequency transformer is connected directly. i.e., without an intermediately connected electrical line, with the first switching contact of the second switch. A second switching contact of the second switch may form a second terminal of the output.

The first terminal of the primary side of the high-current transformer and the second terminal of the primary side of the high-current transformer are preferably each connected via a corresponding line constructed as a plate with the first terminal and the second terminal, respectively, of the output of the inverter, wherein the plates are arranged in parallel at least in a center region between end regions of the plates that are connected with the terminals of the primary side or the terminals of the output of the inverter. The parallel regions of the plates may have a small spacing therebetween. The spacing is preferably as small as possible and/or permissible, for example to reduce the risk of arcing between the plates.

A first terminal of an input of the inverter and a second terminal of the input of the inverter may each be connected via an electrical line implemented as a plate with a first terminal and a second terminal, respectively, of a DC link capacitor. These plates may also be arranged in parallel at least in a center region between the end regions of the plates that are connected with the terminals of the DC link capacitor or the terminals of the output of the inverter. The parallel regions of the plates have preferably a small spacing therebetween. The spacing is preferably as small as possible and/or permissible, for example, to reduce the risk of arcing between the plates.

The high-current transformer may be a transformer with a transformer core. Two secondary windings with opposing winding directions forming the secondary side of the transformer core may be arranged on the transformer core. The secondary windings may each have a first terminal and a second terminal, wherein a first terminal and a second terminal of each secondary winding forms a first terminal and a second terminal of the secondary side of the high-current transformer, which together then form an output of the secondary side of the high-current transformer. The second terminals may also be combined to a common second terminal. Preferably, no voltage drop occurs between the first terminals of the two outputs of the secondary side during the operation of the arrangement.

In one embodiment of the transformer with two outputs on the secondary side, the arrangement according to the invention preferably has two first branches and one or two second branches.

The first terminal of each output of the secondary side may be connected via a first branch and the second output may be connected via a second branch with a first and a second output, respectively, of the arrangement, wherein the outputs of the arrangement are connected in series and no voltage drop occurs across the series connection during the operation of the arrangement.

A converter arrangement according to the invention in conjunction with an arrangement for supplying low-frequency AC current with a frequency between 40 and 70 Hz may be part of a current supply arrangement. The arrangement for supplying the low-frequency AC current may have at least one output which is arranged in parallel with the series connection of the outputs of the converter arrangement, wherein terminals of the output of the arrangement supplying the low-frequency AC current are connected with the first terminal of one of the outputs of the converter arrangement.

The current supply arrangement may be used to supply power to a reactor for producing polysilicon by vapor deposition, for example according to the Siemens process. The loads connectable to the current supply arrangement, in particular to the outputs of the converter arrangement, are then silicon rods or thin silicon rods.

The arrangement for supplying a low-frequency current may have a transformer with several secondary-side taps. With the exception of a terminal for a secondary-side neutral conductor, the taps may be connected via AC current controllers with a first terminal of the output of the arrangement for supplying the low-frequency current. A second terminal of the output is connected with the secondary-side neutral conductor.

The AC current controllers may be controlled in voltage sequence control. Such control is disclosed, for example, in the textbook “Thyristorised Power Controllers” by G. K. Dubey, S. R. Doradla, A. Joshi and R. M. K. Sinha (ISBN 978-0-85226-190-3) and in various publications from the applicant or from companies affiliated with the applicant.

### BRIEF DESCRIPTION OF THE SEVERAL VIEWS OF THE DRAWING(S)

Exemplary embodiments of the invention will now be described with reference to the appended figures, which show in

FIG. 1 in a schematic diagram, the configuration of a first part of a converter device,

FIG. 2 in a schematic diagram, the configuration of a first exemplary embodiment of a second part of a converter device,

FIG. 3 in a schematic diagram, the configuration of a second exemplary embodiment of a second part of a converter device, and

FIG. 4 in a schematic diagram, the configuration of a third exemplary embodiment of a second part of a converter device.

### DETAILED DESCRIPTION OF THE INVENTION

The exemplary configurations of parts of an arrangement according to the invention illustrated in the figures shows schematically the arrangement of the various components of the arrangement and their electrical connection. The mechanical connections of the components to a control panel or parts of a control panel, for example to a frame of the control panel, are not shown.

Also not shown is the interior configuration of the components which, however, is indicated by symbols corresponding to their function.

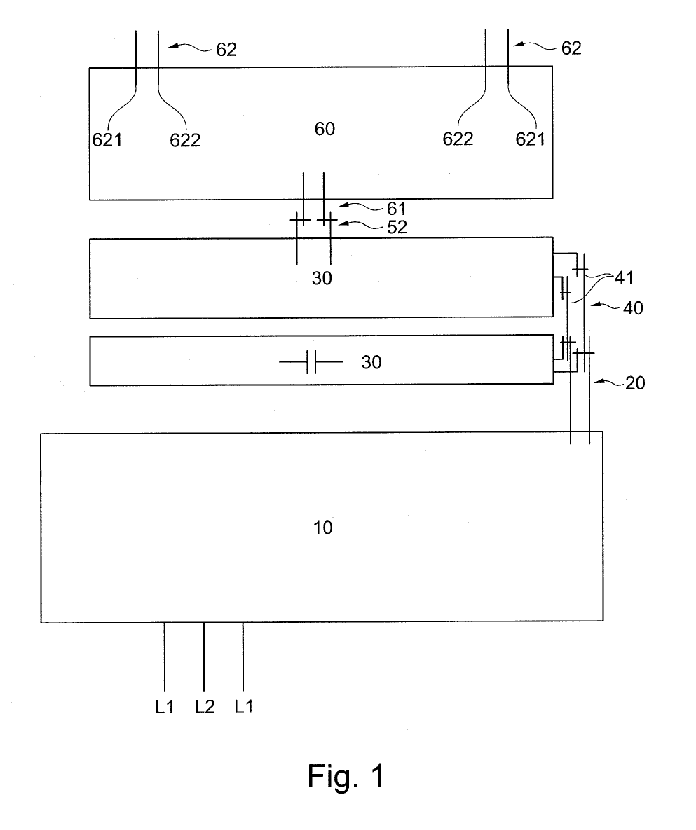

FIG. 1 indicates with the reference symbol 10 a rectifier which receives current from a three-phase grid L1, L2, L3 and rectifies this current. The rectifier 10 can be a conventionally constructed three-phase rectifier, for example a B6C circuit. The terminals of an output of the rectifier 10 are connected to DC link capacitors 30 which are sequentially arranged one after the other perpendicular to the drawing plane and are electrically connected in parallel with each other and with the output of the rectifier.

The DC link capacitors 30 are also connected in parallel with an input of an inverter 50. For this purpose, the terminals of the DC link capacitors 30 and the terminals of the input of the inverter 50 are connected with each other by electrical lines 40. The electrical lines 40 between the terminals of the DC link capacitors 30 and the terminals of the input of the inverter 50 are implemented as plates 41, preferably as copper plates.

The DC voltage produced by the rectifier 10 is essentially present the DC link circuit; however, a high-frequency AC voltage that is passed through from the inverter 50 is superimposed on the DC voltage. The high-frequency AC voltage is short-circuited by the DC link capacitors 30 and is therefore not present at the output of the rectifier 10. The electrical lines 20 between the rectifier 10 and the DC link capacitors 30 need therefore not be designed for a high-frequency current; however, the electrical lines 40 between the DC link capacitors 30 and the input of the inverter 50 must be designed for a high-frequency current.

The two plates 41 conducting the current between the DC link capacitors 30 and the input of the converter 50 are routed in parallel and have the least possible spacing therebetween.

The inverter 50 is a conventional inverter, for example a single-phase full-bridge inverter, a series resonant inverter or a pulse inverter, with a high-frequency AC voltage present at its output 52.

The output 52 of the inverter 50 is directly, i.e., without an intermediately connected electrical line, connected to an input 61 of a transformer 60. The transformer has two outputs 62 on the secondary side. On one hand, the voltage as well as the current can be transformed with the transformer 60. On the other hand, two AC voltages with equal effective voltages and opposite phases can be supplied at the outputs. This is attained with secondary windings having an opposite winding sense through which the same magnetic flux passes. The outputs 62 have each a first terminal 621 for a phase conductor and a second terminal 622 for a neutral conductor. The second terminals 622 are connected with each other (not illustrated) inside or outside the transformer 60 and form on the secondary side a neutral conductor of a secondary-side two-phase AC current system with a phase shift of 180° between the strand voltages. The two first terminals 621 form phase conductors of the two-phase AC current system. No voltage drop occurs between the two first terminals 621, i.e., the conductor voltage is zero.

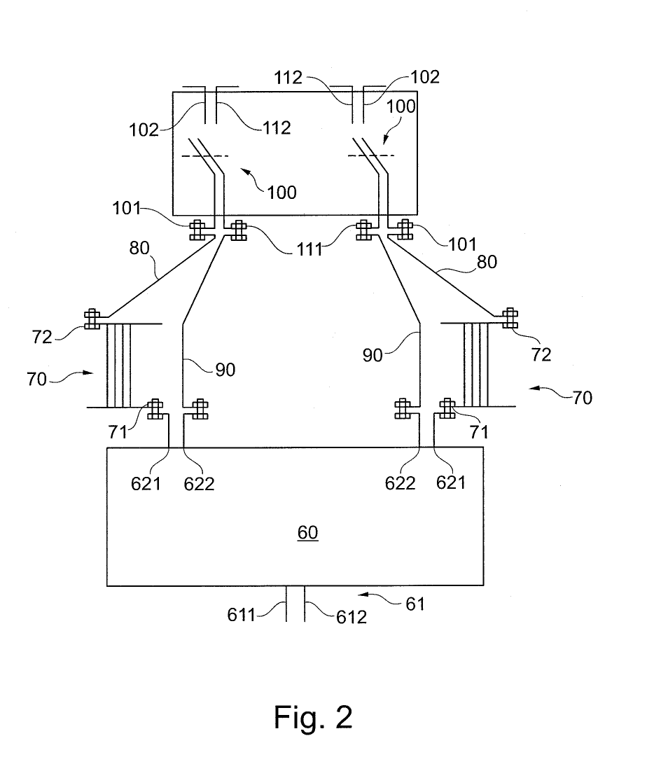

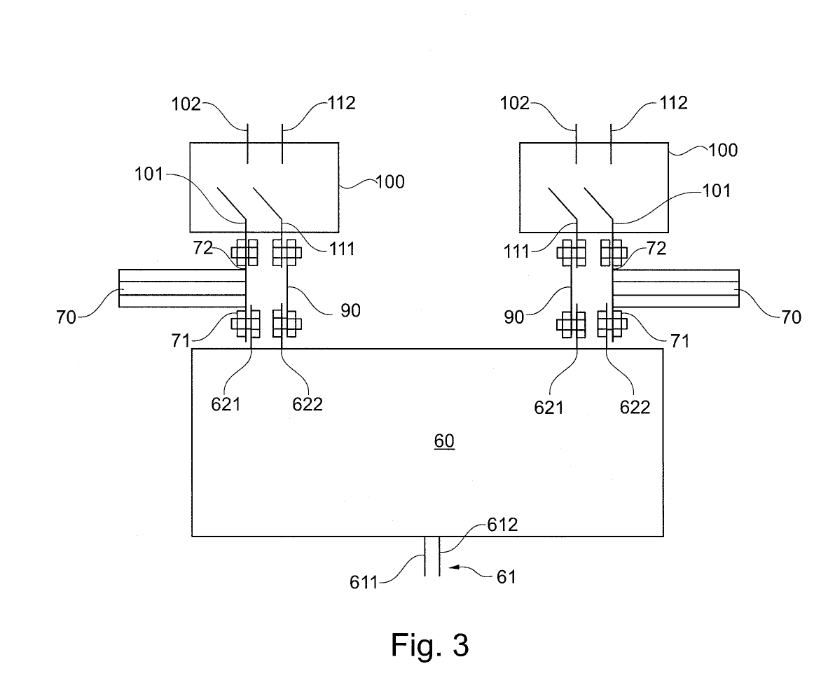

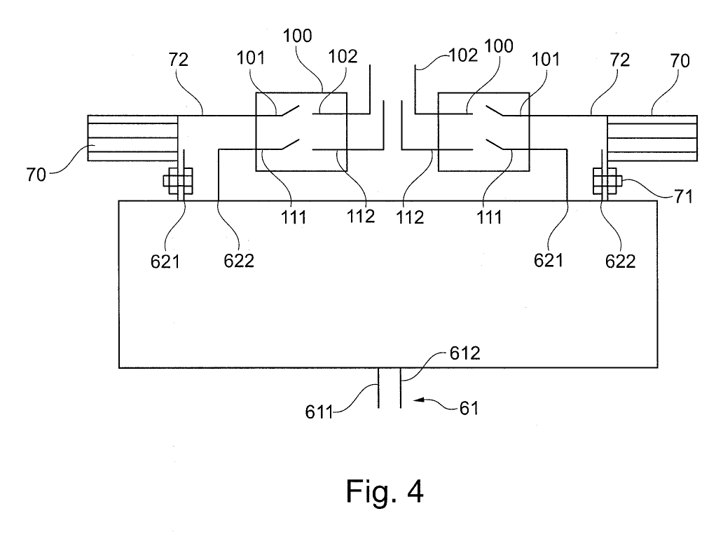

The first terminals 621 of the outputs 62 of the transformer 60 are each connected directly, i.e., without an intermediately connected electrical line, to a first terminal 71 of a capacitor 70. Second terminals 72 of the capacitors 70 are connected either via an intermediate electrical line 80 (FIG. 2) or directly, i.e., without an intermediately connected electrical line (FIG. 3, FIG. 4), to a corresponding first contact 101 of one of the two first switches 100.

The first switches 100 have each a second contact 102, with the respective second contacts forming the first terminals of the two outputs of the arrangement according to the invention. The first contact 101 and the second contact 102 of a first switch 100 can be electrically connected with each other by switching.

The second terminals 622 of the outputs 62 of the transformer 60 are each connected either via an intermediate electrical line 90 (FIG. 2, FIG. 3) or directly, i.e., without an intermediately connected electrical line (FIG. 4), with a corresponding first contact 111 of a second switch 110.

The second switches 110 have second contacts 112 which form a second terminal of an output of the arrangement according to the invention. The first contact 111 and the second contact 112 of a second switch 110 can also be electrically connected with each other by switching.

1. An arrangement for converting current comprising
an inverter (50) for producing AC current with a frequency between 2 and 250 kHz from DC current,
a high-current transformer (60) for transforming AC current from the primary side to a secondary side with a nominal current of 300 A at a nominal voltage from 0 to 700 V on a primary side to a current with a nominal current from 0 A to 1500 A at a nominal voltage from 0 to 100 V on the secondary side of the high-current transformer (60), and
at least one capacitor (70) for filtering a voltage having a frequency of less than 2 kHz present on at least one output (102, 112) of the arrangement,
wherein a first terminal of the output (52) of the inverter (50) is connected with a first terminal of the primary side of the high-current transformer (60), wherein a second terminal of the output (52) of the inverter is connected with a second terminal of the primary side of the high-current transformer,
wherein in at least one first branch, a first terminal (621) of the secondary side of the high-current transformer (60) is connected with a first terminal (71) of the capacitor (70) and a second terminal (72) of the capacitor (70) is at least indirectly connected with a first terminal (102) of the output (102, 112), and
wherein in at least one second branch, a second terminal (622) of the secondary side of the high-current transformer (60) is at least indirectly connected with a second terminal (112) of the output (102, 112), and
wherein on a first side of the high-current transformer (60) the terminals (611, 612) of the primary side are led out from the high-current transformer (60) and on a second side of the high-current transformer (60) the terminals (621, 622) of the secondary side are led out from the high-current transformer (60),
wherein the inverter (50) is arranged on the first side of the high-current transformer (60) and the at least one capacitor (70) is arranged on the second side of the high-current transformer (60), and
wherein the at least one first terminal (621) of the secondary side of the high-current transformer (60) is connected directly, without an intermediately connected electrical line, with the first terminal (71) of the at least one capacitor (70).

2. The arrangement according to claim 1, wherein the first terminal (71) is led out from the at least one capacitor (70) on a first side of the at least one capacitor (70), and the second terminal (72) is led out from the at least one capacitor (70) on the second side of the at least one capacitor (70).

3. The arrangement according to claim 2, wherein the second terminal (72) of the at least one capacitor (70) is connected directly and without an intermediately connected electrical line with a first switching contact (101) of a first switch (101, 102).

4. The arrangement according to claim 3, wherein a second switching contact (102) of the first switch (101, 102) forms a first terminal of the output.

5. The arrangement according to claim 1, wherein the second terminal (622) of the secondary side of the high-current transformer (60) is connected via an electrical line (90) with a first switching contact (111) of a second switch (111, 112).

6. The arrangement according to claim 5, wherein the electrical line (90) is a plate, in particular a copper plate.

7. The arrangement according to claim 5, wherein a second switching contact (112) of the second switch (111, 112) forms a second terminal of the output.

8. The arrangement according to claim 1, wherein the first terminal (611) of the primary side of the high-current transformer (60) and the second terminal (612) of the primary side of the high-current transformer (60) are each connected via an electrical line implemented as a plate with the corresponding first terminal and the corresponding second terminal of the output of the inverter (50), and wherein the plates are arranged in parallel at least in a center region located between the end regions of the plates connected with the terminals of the primary side or the terminals of the output of the inverter.

9. The arrangement according to claim 1, wherein a first terminal of an input of the inverter (50) and a second terminal of the input of the inverter are each connected via a corresponding line constructed as a plate (41) with a corresponding first terminal and a corresponding second terminal of a DC link capacitor (30), and
wherein the plates (41) are arranged in parallel at least in a center region located between the end regions of the plates connected with the terminals of the DC link capacitor (30) or the terminals of the input of the inverter (50).

10. The arrangement according to claim 1, wherein the high-current transformer (60) is a transformer (60) with a transformer core and two secondary windings arranged on the transformer core which have an opposing winding sense and have each a first terminal and a common second terminal, wherein one of the first terminals and the second terminal form a first terminal (621) and a second terminal (622) of an output (62) of the secondary side of the transformer (60), and wherein no voltage drop occurs between the first terminals (621) of the output (62) during the operation of the arrangement.

11. The arrangement according to claim 10, wherein the first terminal (621) of each output (62) of the secondary side is each connected via a corresponding first branch and the second terminal is connected via at least one second branch with a corresponding first and second terminal of the arrangement, and
wherein the outputs of the arrangement are connected in series and no voltage drop occurs across the series connection during the operation of the arrangement.

12. A current supply device with a converter arrangement according to claim 1 and an arrangement for supplying low-frequency AC current with a frequency between 40 and 70 Hz, which has at least one output arranged in parallel with the series connection of the outputs of the converter arrangement, wherein terminals of the output of the arrangement for supplying low-frequency AC current are connected with the first terminal of one of the outputs of the converter arrangement.

13. The arrangement according to claim 6, wherein a second switching contact (112) of the second switch (111, 112) forms a second terminal of the output.
